(19) United States
(12) Patent Application Publication
(10) Pub. No.: US 2001/0047286 A1
(43) Pub. Date: Nov. 29, 2001

(54) Task and personnel verification and tracking system and method

(76) Inventors: Cedric F. Walker, New Orleans, LA (US); Kevin J. Bianchini, New Orleans, LA (US); Edward W. Karp, New Orleans, LA (US)

Correspondence Address: MICHAEL D CARBO, PLC, 700 WHITNEY BANK BUILDING, 228 ST CHARLES AVENUE, NEW ORLEANS, LA, 70130, US

(21) Appl. No.: 09/767,438

(22) Filed: Jan. 23, 2001

Related U.S. Application Data
(60) Provisional application No. 60/045,436, filed on May 2, 1997.
(60) Provisional application No. 60/081,369, filed on Apr. 10, 1998.
(60) Provisional application No. 60/081,896, filed on Apr. 15, 1998.

(51) Int. Cl. G06F 17/60

(52) U.S. Cl. 705/9; 705/11; 705/34

(57) ABSTRACT

A task and personnel verification and tracking system and method receives a request for service; establishes a database account associated with the request; assigns an individual provider to perform service at a site; enters information about the provider and the service into the database; provides, to a carryable computer, information required to render the service; causes the computer to store provider data; causes the computer to store biometric property sensor information; enters into the computer information associated with service; stores information upon completion of the service; transfers stored data and information to the database; determines whether data and information transferred into the database match those previously stored; and updates data and information stored on the database.

### CROSS-REFERENCE TO RELATED APPLICATIONS

This application claims the benefit of prior filed copending patent application Ser. No. 09/071,928 filed on May 1, 1998, [Attorney Docket No. 725-1], prior filed copending patent application Ser. No. 09/060,855 filed on Apr. 15, 1998, [Attorney Docket No. 725-2], prior filed copending patent application Ser. No. 09/292,511 filed on Apr. 15, 1999, [Attorney Docket No. 725-6] prior filed Provisional Application No. 60/045,436 filed on May 2, 1997, prior filed Provisional Application No. 60/045,436 filed on May 2, 1997, prior filed Provisional Application No. 60/081,369 filed on Apr. 10, 1998, and prior filed Provisional Application No. 60/081,896 filed on Apr. 15, 1998, all of which are incorporated herein by reference in their entirety.

### STATEMENT REGARDING FEDERALLY SPONSORED RESEARCH OR DEVELOPMENT

Not applicable

### BACKGROUND OF THE INVENTION

1. Field of the Invention

The invention relates to a system and method for initiating, delivering, tracking, billing for and auditing services and tasks. More particularly, this invention relates to initiating and delivering products/services to a subject at a remote site and to tracking, verifying, billing for and for auditing the services rendered to the remote subject and/or and the tasks performed at the remote site.

2. Description of Related Art Including Information Disclosed Under 37 CFR 1.97 and 37 CFR 1.98.

Many businesses provide products and services requiring that employees or independent contractors visit the recipients of the products and services or visit a remote site to perform a task. For instance, many health care providers send nurses and other medical professionals and paraprofessionals to the homes of patients to provide health care services, including collecting information and data. Similarly, parcel delivery services deliver parcels directly to businesses and individuals. Also, workers and others visit remote sites to perform repair, maintenance and other tasks. Product and service providers will frequently benefit from tracking: (1) the identity of the individual service/product provider; (2) the identity of the individual product/service recipient; (3) the arrival and departure times of the service/product provider or, alternatively, the duration of the service activity; (4) the location at which the service was rendered or the product was delivered; and (5) what activity was performed, what service was rendered, or what product was delivered.

Product/service providers sometimes receive instructions from, send bills to, and provide reports to the product/service recipients. Additionally, product service providers may receive instructions from, send bills to, and provide reports to third parties. For example, home health agencies (HHA's) often receive from physicians a signed order prescribing a visitation protocol (specifying a list or categories of services to be performed and their frequency) and the number of visits to be made. HHA's typically send bills to third party payors, including insurers, health maintenance organizations and government agencies.

Difficulties and inefficiencies attend the matching of billing entries with signed orders and the auditing of the level and quality of the activities and the groups of activities performed by the individual product/service provider. Through inattention and sometimes intentionally, product/service providers provide and bill for more products/services than were requested or ordered. Unless the products/services provided can be readily matched with specific requests and orders, billing errors can occur. Product/service providers, particularly those who use emerging technologies to record data, sometimes must supplement or amend data records regarding the who, what, when and where relating to the products/services provided in order to complete or correct the data records. Also, data records generated or stored or magnetic media can be easily changed. Some method or means of auditing the authenticity of and changes to data records is desirable. Also, data records generated or stored on magnetic media can be easily changed. Use of a disinterested third party to collect and hold data is often desirable.

Numerous systems and methods exist for locating the position of a target emitting a radio, cellular or other wireless signal. Some proposed systems and methods use an existing wireless communication network to locate the position of any active phone or transceiver unit in the network. For example, U.S. Pat. No. 5,855,522 to Sheffer et al. describes a system for locating a portable phone transceiver unit using the reverse voice channel signal transmitted by the transceiver unit. U.S. Pat. Nos. 5,218,367, 5,055,851, and 4,891,650 of Sheffer all describe locating systems that utilize cellular technology. Satellite-based systems and methods use the Global Positioning System, or GPS, with receivers receiving signals from orbiting satellites in order to determine approximate location.

Some proposed systems and methods combine a GPS transceiver with a carryable computer or other information/data receiver/transmitter that collects data. The carryable computer can, by means of programmed prompts or otherwise, collect identification and other information. For example, fingerprint, voice, handwriting or the biometric property sensors integrated into a carryable computer can collect identification data from a product/service provider and from the product/service recipient. Other data, corresponding to recipient status and condition can also be collected on the carryable computer or other automated data collection device.

Some systems that collect identification data, or data regarding a task, activity, product or service, utilize a central computer system to provide interactive communication with the remote site. For example, U.S. Pat. No. 5,553,609 to Chen et al. describes a system and method for remote monitoring of a subject. U.S. Pat. No. 5,897,493 to Brown describes a system and method remotely querying an individual by means of a central computer system and a remote apparatus. A disadvantage of these central computer/remote apparatus systems is that they require distributed communication systems in communication with each remote site. Also, remote monitoring and interactive communication is not always necessary, and large bandwidth is required for visual and voice communication.

Current systems and methods for tracking tasks performed and services rendered at distributed sites, for verifying the identity of the individual task/service providers and recipients, and/or for tracking the tasks/services performed, do not conveniently allow businesses providing a task/service to use third party web-based verification, compliance and audit services.

### BRIEF SUMMARY OF THE INVENTION

It is an object of this invention to provide a new and improved system and method for initiating, delivering, tracking, billing for, and auditing services and tasks. It is a further object of this invention of provide a computer network and web-based system and method for utilizing an application database service provider: (1) to provide initial information to a task/service provider; (2) to retrieve, usually at least once per day, data collected by the task/service provider, (3) to process the collected data, issue reports and requests, and modify the initial information.

These and other objects and advantages of the subject invention will become apparent from the following detailed description of the preferred and alternative embodiments, when taken in conjunction with the various figures of the drawing.

### BRIEF DESCRIPTION OF THE DRAWING:

In the detailed description of presently preferred embodiments of the present invention which follows, reference will be made to the drawing comprised of the following figures, wherein like reference numerals refer to like elements in the various figures and wherein:

FIG. 1 is a simplified block diagram showing initial setup of a new or existing patient;

FIG. 2 is a simplified block diagram showing scheduling of a patient visit;

FIG. 3 is a simplified block diagram showing acts involved in accomplishing a patient visit;

FIG. 4 is a simplified block diagram showing acts involved in synchronizing, analyzing, and evaluating data and information after completion of all visits for a day;

FIG. 5 is a simplified block diagram showing acts involved in performing auditing and billing associated with the services rendered;

FIG. 6 shows a portion of a sample record for a patient visit; and

FIG. 7 shows another portion of a sample record for a patient visit.

### DESCRIPTION OF THE PREFERRED EMBODIMENT:

According to one aspect of the present invention, a carryable computer system is provided, which utilizes a location sensing system, preferably a GPS tracking system. Each GPS or other tracking system may be an integrated device or a modular device, that connects to the carryable computer system and that provides position data, and preferably provides time data. Alternatively, the carryable computer has a clock to provide time data.

The carryable computer collects data, preferably by means of programmed prompts. The carryable computer preferably has back/forward capability for accessing programmed prompts, some rudimentary editing capability, and some means for checking limits that can prompt data correction or reentry.

The carryable computer also utilizes a biometric property sensor, preferably a fingerprint sensor, to provide identification of the task/service provider and that may also be used to identify the recipient. The biometric property sensor may be integrated into the carryable computer or may be modular. If the GPS or other tracking system and the biometric property sensor are modular, they can be swappable so that both need not be connected simultaneously.

The carryable computer collects “who,” “what,” “when,” and “where” data for each site visit. The “who” data are data corresponding to a biometric property of the task/service provider, and may also be recipient identification data. The “when” data are time data from an integrated computer clock upon start and end of a task/service, or else may be time data from the GPS signal. The “where” data are position data from the GPS, or else may be position data from another location tracking system. The “what” data are data corresponding to the tasks/services performed. The data is recorded in memory of the carryable computer, preferably in discrete field fields.

Carryable computers that contain features useful in performing the present invention include: (1) “The Visor” (Handspring, Inc., Mountain View, Calif.), which can be purchased with a GPS location sensing system that plugs into the socket on the back of the carryable computer; (2) a biometric sensor incorporated into a Palm Pilot carryable computer (Biolink, U.S.A., Mountain Lakes, Fla.); and (3) a biometric sensor incorporated into a standalone computer chip (Veridicom, Inc.).

Throughout a workday, the task/service provider collects data at various sites. The collected data is transferred to the database either upon completion of each data record or in a batch, usually at the end of the day.

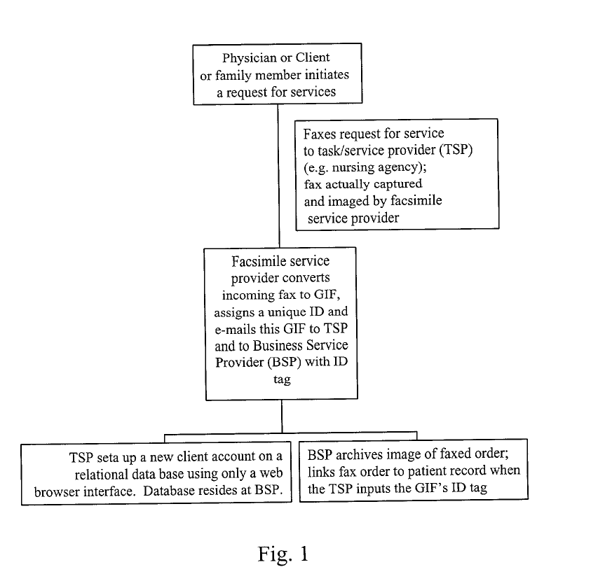

Referring to FIG. 1, the recipient of services or a third person initiates an order, authorization or request, preferably via a facsimile request for service to the business service provider. The facsimile is captured and imaged by a facsimile service provider, who converts the facsimile to a graphical interface file (GIF), or to another electronic image representation, and assigns a unique identification number. The facsimile service provider emails this GIF to the task/service provider (e.g. the home health agency) and to the business service provider. The task/service provider, using only a web browser or other computer-based or web-based interface, establishes a new client account on a database that resides on the business service provider's computerized database.

The business service provider archives the electronic image of the faxed order, authorization, or requests, and links this to the recipient's record when the task/service provider inputs the GIF identification tag.

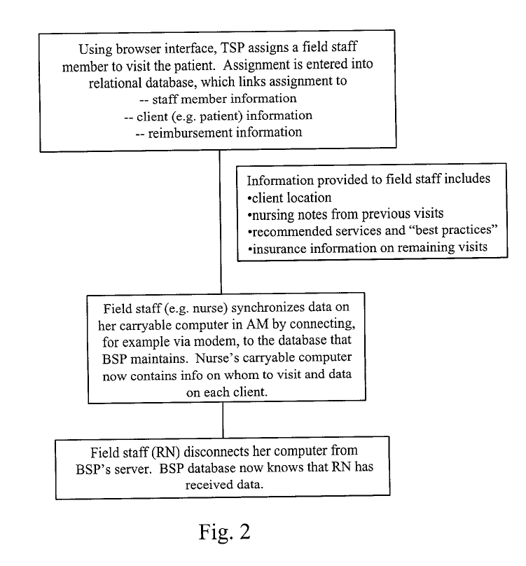

Referring to FIG. 2, the business providing a task/service assigns one or more individuals to perform a task/service. The business preferably uses a web-browser interface and an application service provider to assign the individual to visit one or more sites. The assignment is entered into a relational database, preferable an Oracle- style database, which links information about the individual provider, the site, the recipient, the services authorized/ordered, and the number of visits to be made and their frequency.

Information provided to the individual provider may include site location, a map or other geographic location information, a telephone number for the site, authorized/ordered services and protocols, number of visits to be made, relevant other information about the service/product recipient, and information from previous visits, if any. The information is provided to the individual provider preferably by a one-button file synchronization connection (i.e., a “hot-sync” connection), via modem from the database maintained by the application service provider, to the individual's carryable computer, or, alternatively, by any connection, wired or wireless, between the database and the carryable computer. A hot-sync connection via modem allows the application service provider to verify that the individual provider received the data.

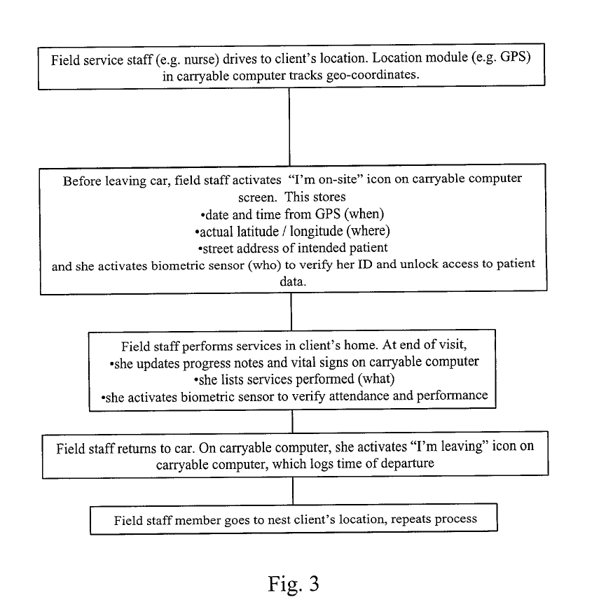

Referring to FIG. 3, the individual provider travels with the carryable computer to the specified site. The GPS tracking system tracks the geocoordinates of the carryable computer. Upon arrival at the site the provider points to or otherwise activates an arrival icon on the screen of the carryable computer to store “when” data (date and time) and “where” data (actual longitude and latitude) from the GPS, and, alternatively, street address of the site (either calculated or from a look-up table). The individual provider activates a biometric property sensor associated with the carryable computer to provide “who” data, thereby unlocking data about the site, the recipient and/or the task. Preferably, the biometric property sensor is a finger sensor that determines whether the individual's fingerprint matches the downloaded fingerprint data. Also, the recipient's biometric property data may be obtained.

The individual provider performs the task/service at the site. During or at the completion of the task/service, the provider inputs into the carryable computer “what” data corresponding to the task/services performed and the status/condition of the recipient. At completion, the provider again activates the biometric property sensor, thereby verifying that individual's attendance and performance, and may also capture biometric data from the recipient to document that the recipient received the service or product. The provider travels to any other assigned sites and repeats the above-described process.

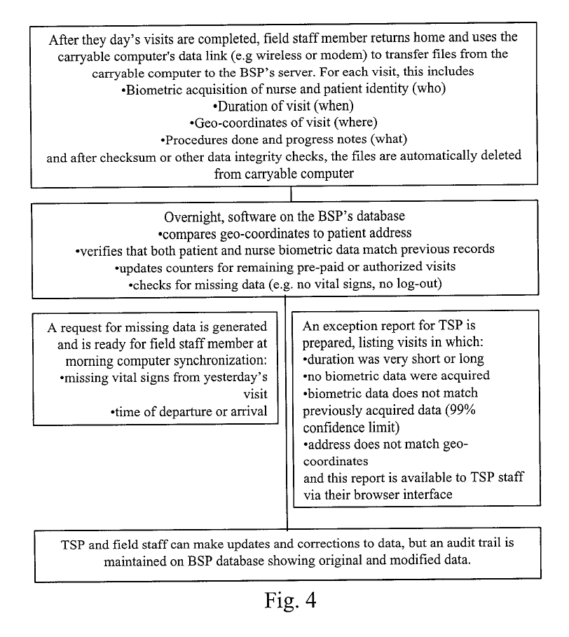

Referring to FIG. 4, at the end of the day, or after any other convenient interval, the individual provider transfers, via modem or wireless or other channel, to the application service provider's database the data files for each site visit. This data include the who, what, when and where data described above. A log file is maintained for each hot-sync. After a data transfer integrity verification, either a checksum or some other method, the files on the carryable computer are automatically deleted by the transmission of a null data set from the database computer to the carryable computer or by transmission of an erase command to the carryable computer.

The service provider runs software to compare the GPS coordinates with the site address, to verify that the individual provider and the recipient match stored records, to determine whether requested tasks/services were performed, to update data fields for the remaining number of visits, and to check for missing data, including missing status/condition data and missing provider data such as log-in or log-out times. A request for missing data is generated and is made available for the next time the task/service provider hot-syncs into the database.

Additionally, reports may be prepared listing site visits where the duration was unusual or abnormal, where biometric data is missing or corrupted, where biometric data does not match previously acquired data within a specified tolerance, or where the site address does not match the GPS coordinates within normal GPS resolution. These reports are accessible to the business provider and to the individual provider, and the database can even be changed or updated by either of them, but an audit trail is retained on the business service provider's database showing original and updated/corrected data.

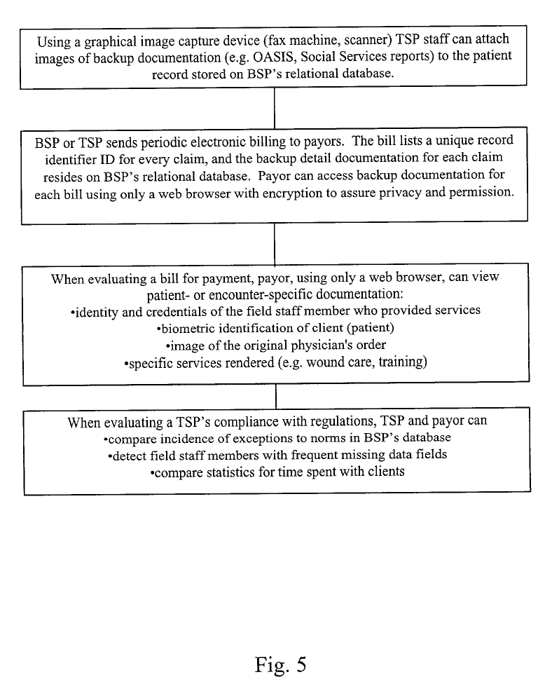

Referring to FIG. 5, via facsimile, the task/service provider can add graphical images in electronic form to the patient record. The graphical images can include OASIS (i.e., an initial data acquisition form for patient assessment and evaluation) and images of reports submitted by social service entities.

Either the database business service provider or the task/service/product provider sends periodic bills, preferably in electronic format, to payors. Each bill lists a unique record identifier ID for every claim. The type of detail documentation resides on the database. The detail documentation includes the original authorization/request, the patient ID, and any other required forms.

When evaluating a bill for payment, the payor can view, via a web browser or other internet access device, site-specific or recipient-specific documentation such as the identify and credentials of the individual task/service provider, the biometric identification of the recipient, and an image of the original authorization/order. When evaluating a task/service/product provider's compliance with rules and regulations, the business provider and the database provider can compare the relative incidence of norms and exceptions in the database, detect individual providers who have frequent missing data fields, and compare statistics for time spent with a patient or any group of patients.

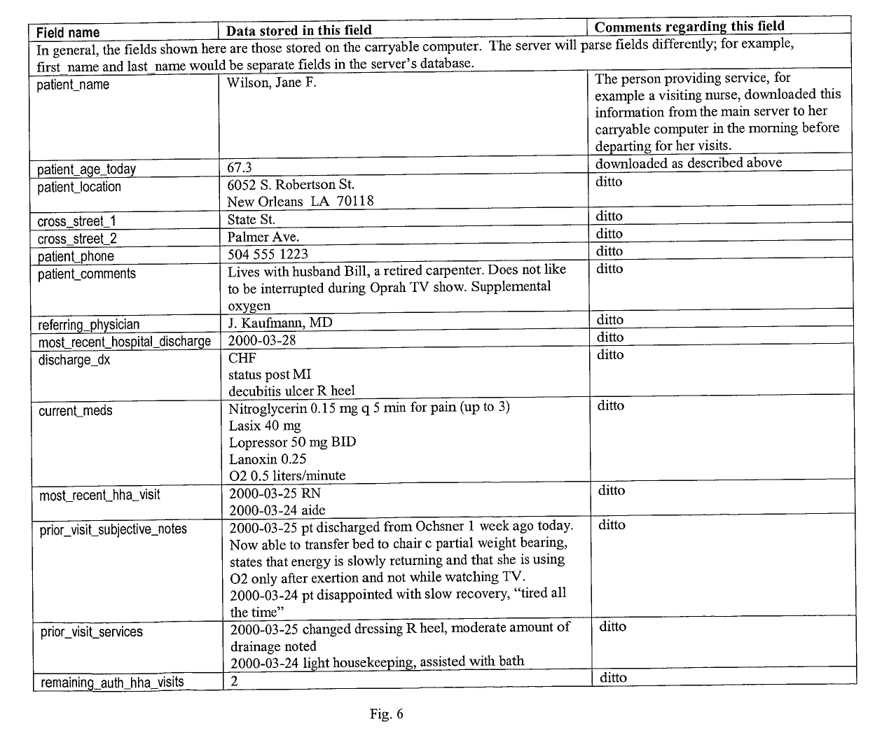

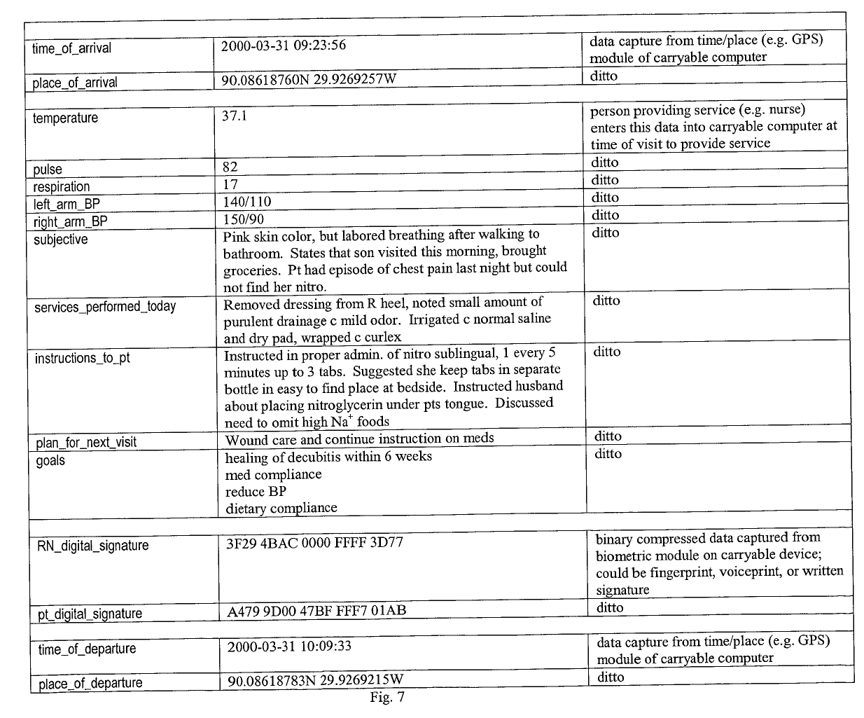

Referring to FIGS. 6 and 7, records for a visit include various fields for collecting, storing, or displaying information and data relevant to the visit.

While the foregoing detailed description sets forth preferred embodiments of the invention, it will be understood that many variations may be made to the embodiments disclosed herein without departing from the spirit and true scope of the invention.

What is claimed is:

1. A method for providing services to distributed sites, the method comprising the steps of:
(a) receiving a request for a service;
(b) establishing on a relational database an account associated with the request;
(c) assigning an individual provider to perform the service at a site, and entering first information, about the individual provider and the service, into the relational database;
(d) providing, to a carryable computer associated with the individual provider, second information, associated with the site, and third information, required to render the service, the carryable computer having means for sensing the location of the individual provider carrying the carryable computer and having means for sensing a biometric property of the individual provider;
(e) causing the carryable computer to store date and/or time data when the individual provider arrives at the site;
(f) causing the carryable computer to store the second information associated with the site and/or the third information required to render the service, when the assigned individual provider activates the biometric property sensing means, the carryable computer storing identification information associated with the individual provider's activation of the biometric property sensing means;
(g) performing the service at the site;
(h) entering into the carryable computer fourth information, associated with the performed service;
(i) causing the carryable computer to store fifth information, associated with the identity of the individual provider or with a recipient of the performed service, upon completion of the performed service;
(j) transferring to the relational database the date and/or time data, the identification information, and the fourth information;
(k) determining whether the identification information and the performed service information transferred into the relational database matches data and information previously stored on the relational database; and
(l) updating data and information stored on the relational database.

2. The method according to claim 1, wherein the request for service comprises a facsimile request that is converted to an electronic image representation, and an identification code is associated with the file.

3. The method according to claim 2, wherein the request for service comprises a facsimile request that is converted to an electronic image representation, and an identification code is associated with the file.

4. The method according to claim 2, wherein the assigning step comprises transmitting information identifying the individual provider to the relational database via web-browser.

5. The method according to claim 4, wherein the relational database links the identifying information, the second information and the third information.

6. The method according to claim 1, wherein the information provided to the carryable computer is provided by a hot-sync connection via modem or other wired connection from the relational database.

7. The method according to claim 6, wherein the information provided to the carryable computer is provided by a wireless connection between the database and the carryable computer.

8. The method according to claim 1, wherein the means for tracking comprises a GPS transceiver connected to the carryable computer.

9. The method according to claim 8, wherein the means for tracking is integrated into the carryable computer.

10. The method according to claim 1, wherein the performed service information is collected by means of programmed prompts.

11. The method according to claim 1, wherein the biometric property sensing means is a fingerprint capture device connected to the carryable computer.

12. The method according to claim 11, wherein the biometric sensing means is integrated into the carryable computer.

13. The method according to claim 1, wherein the tracking means is a GPS receiver connected to the carryable computer, the biometric sensing means is a biometric sensor connectable to the carryable computer, and wherein the receiver and the biometric sensor are hot-swappable.

14. The method according to claim 1, wherein the transferring to the relational database is accomplished by a connection via a modem or via a wireless link.

15. The method according to claim 14, wherein the transferring is checked for data transfer integrity and, after verification of data transfer integrity, the data transferred from the carryable computer is deleted from the carryable computer.

16. The method according to claim 15, wherein the data is deleted by transmission of a null data set or an erase command from a computer associated with the database to the carryable computer.

17. The method according to claim 1, further comprising:
(m) generating a request for missing data, and
(n) preparing a report for out of normal data.

18. The method according to claim 17, wherein the report is accessible to others and can be changed by others, and wherein an audit trail is maintained in the database showing both original and changed information in the report.

19. The method according to claim 1, wherein the service comprises conducting an election.

20. The method according to claim 1, wherein the service comprises performing a census.

21. The method according to claim 1, wherein the service comprises checking medical equipment.

22. The method according to claim 1, wherein the service comprises verifying a drug or other medical prescription.

23. The method according to claim 4, wherein the individual provider is a physician or pharmacist and the identifying information is an original signature or a fingerprint maintained in electronic form on the relational database.

24. The method according to claim 1, wherein the biometric property sensing means comprises scannable identification means.

25. The method according to claim 1, wherein the biometric property sensing means comprises magnetic identification means.

26. The method according to claim 1, wherein the carryable computer includes means for recording sound.

27. The method according to claim 1, wherein the carryable computer includes means for communicating telephonically.

28. The method according to claim 1, wherein the carryable computer includes means for video-conferencing.

29. The method according to claim 1, wherein the carryable computer includes means for capturing video data.

30. The method according to claim 1, wherein the carryable computer includes means for displaying video data.

31. The method according to claim 1, wherein the carryable computer includes means for creating a digitized picture.

32. The method according to claim 1, wherein the carryable computer includes means for displaying a digitized picture.

33. The method according to claim 1, wherein the carryable computer includes means for providing an alarm.

34. The method according to claim 1, wherein the carryable computer has a folio structure and includes a camera.

35. The method according to claim 1, wherein the carryable computer has a folio structure and includes a video recorder.

36. The method according to claim 1, wherein the carryable computer has a folio structure and includes an audio recorder.

37. The method according to claim 1, wherein the carryable computer has a folio structure and includes a speaker for two-way communication.

38. The method according to claim 1, wherein the transferring step is accomplished via broadband transmission.

39. The method according to claim 1, wherein the determining step is accomplished using a computer associated with the relational database.

40. The method according to claim 1, further comprising the step of analyzing the data and information that has been transferred to the relational database.

41. The method according to claim 1, further comprising the step of evaluating the data and information that has been transferred to the relational database.

42. A system for providing services at distributed sites, the system comprising:
means for generating a request for service;
a relational database having stored therein account information associated with the request for service and having information about an individual service provider and about the service;
means for assigning an individual provider to perform service at a site;
means for providing, to a carryable computer associated with the individual service provider, information about the site and information required to render the service;
combined means for tracking the location of the individual provider, for storing date and/or time data about when the individual service provider arrives, is present at, or leaves a site, for storing information associated with the site, for sensing a biometric property of the individual provider or of the recipient of the services, for activating the biometric property sensing means, for storing information associated with an activation of the biometric property sensing means, for storing information required to render the service upon activation of the biometric property sensing means, for storing information associated with the performed service, for storing information about services previously rendered to the recipient, and for storing information associated with the identity of the individual service provider or the recipient upon completion of the service;
means for transferring into the relational database the date and/or time data, the identification information, and the information associated with the completed service;
means for determining whether the information transferred into the relational database matches information stored therein; and
means for updating information stored in the relational database.
